(19) United States
(12) Patent Application Publication
(10) Pub. No.: US 2006/0176318 A1
(43) Pub. Date: Aug. 10, 2006

(54) Method for manipulating artwork to form decorative pieces

(76) Inventors: Virginia Lynn Martin, Copley, OH (US); David B. Keller, Copley, OH (US)

Correspondence Address: SAND & SEBOLT, AEGIS TOWER, SUITE 1100, 4940 MUNSON STREET, NW, CANTON, OH, 44718-3615, US

(21) Appl. No.: 11/349,829

(22) Filed: Feb. 8, 2006

Related U.S. Application Data
(60) Provisional application No. 60/651,388, filed on Feb. 9, 2005.

(51) Int. Cl. G09G 5/00

(52) U.S. Cl. 345/629

(57) ABSTRACT

A method of forming decorative pieces includes copying a portion of a digitized image of a piece of artwork to form a first image, duplicating the first image to form a second image, and transferring the first and second images to a target object. Preferably, the first and second images are mirror images which are merged to provide a first unit which is repeatable to form various patterns. Typically, the first and second images are mirror images about a vertical axis and the first unit is inverted to form a mirror image thereof about a horizontal axis, thus forming a second unit which is merged with the first unit. One typical target object is a wall paper border. Another is a frame used with the image of the piece of artwork. One embodiment includes a two-dimensional image of the piece of artwork and a two-dimensional frame having a three-dimensional appearance.

### CROSS REFERENCE TO RELATED APPLICATIONS

This application claims priority from U.S. Provisional Patent Application No. 60/651,388, filed Feb. 9, 2005, the disclosure of which is incorporated herein by reference.

### BACKGROUND OF THE INVENTION

1. Technical Field

The present invention relates to a method for manipulating digital images of original art to form various decorative pieces. More particularly, the invention relates to a method in which a detail section of the digital image of a piece of artwork is copied and transferred onto a target object in order to provide a desirable decorative effect to the object. Specifically, the method includes duplicating the copied cropped image, forming one or more mirror images thereof and joining the images to one another to form a highly desirable decorative pattern derived from the original piece of art.

2. Background Information

When decorating a home, office or other space, the use of wallpaper, borders, artwork, and floor coverings are generally desirable. Borders may be used with wallpaper to provide decorative accents which accentuate the wallpaper, or may be used independently of wallpaper. Borders can be applied anywhere, but usually are found on a wall, ceiling or chair rail area of a room. While wall coverings and other decorative items are gaining popularity, none of these items are seen to emanate from such a derivative form of original art. More specifically, such wall coverings or borders may be individually designed and may coordinate, but are not derived from such a central-dynamic functional original art source. In addition, frames are generally desirable for use with pieces of art or reproductions thereof which are suitable for hanging. Standard frames come in a wide variety of shapes, textures, profiles and colors, but like the other decorative items noted above, known frames do not incorporate aspects of original art.

As such, there is a need in the art for using such a form of pre-existing original art and manipulating that original art to form images which include portions of the art to form decorative pieces, including those noted above and many other options.

### BRIEF SUMMARY OF THE INVENTION

The present invention provides a method comprising the steps of copying a portion of a digitized image of a piece of artwork to form a first digitized detail section image; duplicating the first detail section image to form a second digitized detail section image; and transferring the first and second detail section images to a target object.

In one aspect of the invention, the first and second detail section images are mirror images of one another and are preferably merged with one another to provide a seamless pattern. In another aspect, mirror images of the merged first and second detail images themselves are formed and merged with the first and second images.

The present invention also provides a frame for a piece of artwork wherein the frame includes an image of a portion of the piece of artwork.

### BRIEF DESCRIPTION OF THE SEVERAL VIEWS OF THE DRAWINGS

FIG. 1 is a diagrammatic view of an original piece of artwork.

FIG. 2 is a diagrammatic view of a computer connected to a digitizing mechanism for creating and inputting a digital image of the piece of artwork.

FIG. 3 is a diagrammatic view of a digital image of the piece of artwork with dot-dash lines showing a selected detail section of the digital image.

FIG. 4 is diagrammatic view of first and second copies of the detail section of FIG. 3.

FIG. 5 is a diagrammatic view of the first and second copies of the detail section of FIG. 4 showing the second copy being moved toward a desired placement location.

FIG. 6 is a diagrammatic view of the first and second copies of the detail section showing the second copy having been horizontally flipped and positioned in the desired placement location to form a mirror image of the first copy with respect to a vertical axis, resulting in a single-mirrored detail section pattern.

FIG. 7 is diagrammatic view showing the mirrored detail section of FIG. 6 having been vertically flipped to form a mirror image thereof with respect to a horizontal axis to produce a double-mirrored detail section pattern having four quadrants each containing a copy of the detail section, with the detail section in the upper left quadrant in the original orientation of FIG. 3; in the upper right quadrant in a mirror image with respect to the vertical axis; in the lower left quadrant in an upside down mirror image of the upper left quadrant image; and in the lower right quadrant in an upside down mirror image of the upper right quadrant image.

FIG. 8 is a diagrammatic view of a virtual molding strip typically used along an edge of the patterns shown in FIGS. 6 and 7.

FIG. 9 is a diagrammatic view similar to FIG. 7 showing the virtual molding strip of FIG. 8 joined to the upper and lower edges of the double mirrored detail section of FIG. 7.

FIG. 10 is a diagrammatic view showing the digital image of the piece of artwork of FIG. 2 with a frame formed from repetitions of the double-mirrored detail section pattern of FIG. 9.

FIG. 11 is a diagrammatic elevational view of a portion of a room showing ceiling, baseboard and staircase wall borders onto which the pattern of FIG. 9 has been transferred in various configurations, and also showing the framed artwork of FIG. 10 hanging on a wall of the room.

Similar numbers refer to similar parts throughout the drawings.

### DETAILED DESCRIPTION OF THE INVENTION

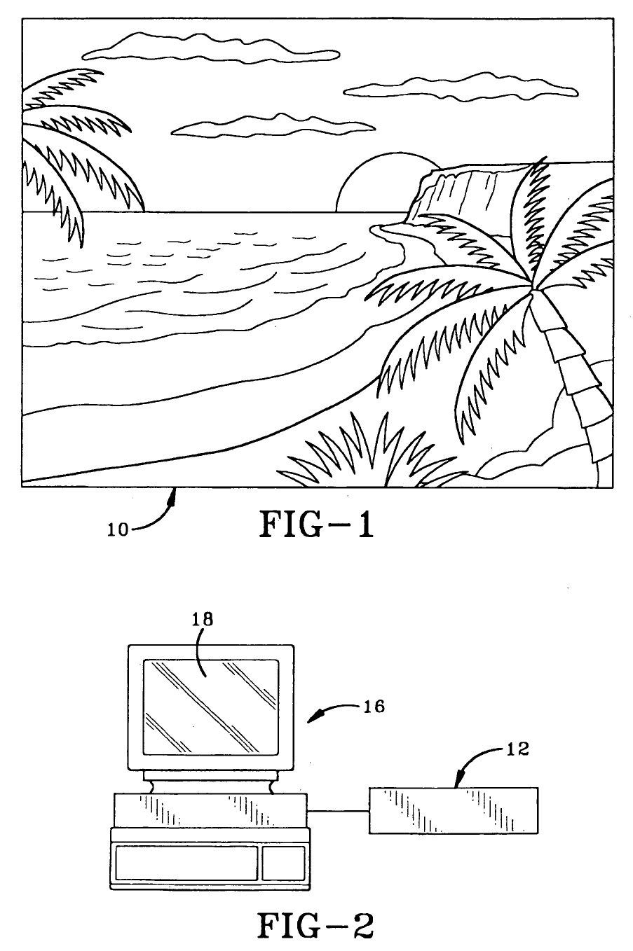

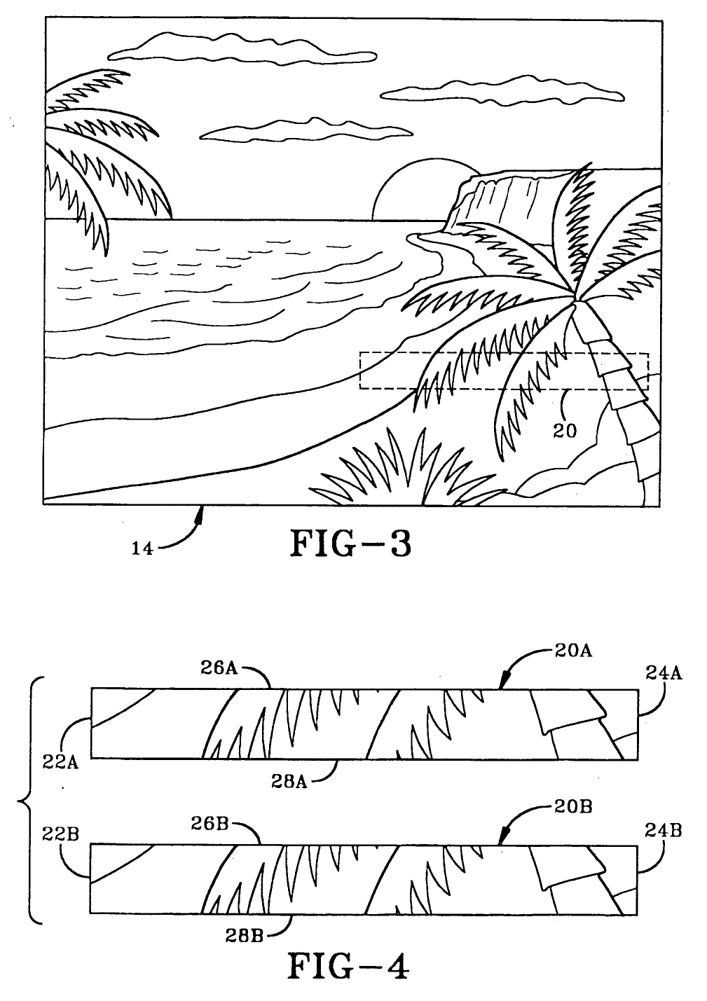

FIG. 1 shows an original piece 10 of artwork, which is used as the starting point of the method of present invention. While piece 10 is represented in the exemplary embodiment as a painting or drawing, any piece of artwork may be utilized. Thus, for example, piece 10 may also be derived from any two- or three- dimensional source, for example, a tapestry, mosaic, photograph, sculpture, pottery form, artistic furniture and so forth. A digitizing mechanism 12 (FIG. 2) is used to create a digital image 14 (FIG. 3) of piece 10. Mechanism 12 may include a digital camera, a scanner or the like. Digital image 14 is then stored in electronic memory via an appropriately programmed computer 16 having a display screen 18. A photo editing software package such as PhotoShop is suitable for the purpose of the present invention.

A portion or detail section 20 (FIG. 3) of piece 10 is then chosen to provide a building block which will be manipulated to form a desirable pattern which is applied to a target object to form a finished product. It is contemplated that section 20 or any pattern using section 20, as further detailed below, may be transferred to a desired object to form the finished product. If desired, image 14 may be manipulated prior to choosing detail section 20. For instance, image 14 may be enlarged, made smaller, stretched or compressed to alter the proportions and so forth. Detail section 20 is then copied to produce a first copy 20A thereof and duplicated to produce a second copy 20B thereof. The manipulation of detail section 20 is done using display screen 18 of computer 16, but for simplicity, the various drawings herein do not show the images on screen 18. First copy 20A has first and second opposed ends 22A and 24A and first and second opposed sides 26A and 28A. Second copy 20B has analogous first and second opposed ends 22B and 24B and first and second opposed sides 26B and 28B. While detail section 20 and the copies thereof are shown as rectangular in shaped, it is contemplated that any shape may be used.

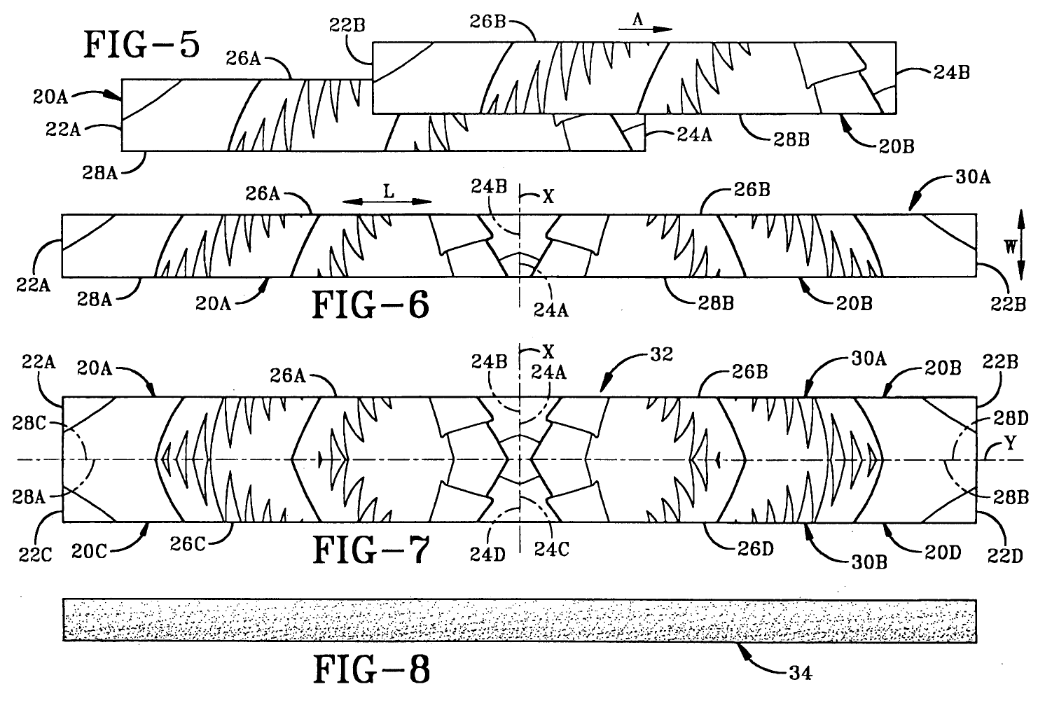

FIG. 5 show second copy 20B being moved, or “dragged”, toward a desired placement location, as indicated at Arrow A, and FIG. 6 shows second copy 20B positioned in the placement location after having been flipped or inverted with respect to a vertical axis X so that first end 22B thereof has shifted to the right and second end 24B has shifted to the left in FIG. 6. The size of copies 20A and 20B may be altered before or after achieving the result shown in FIG. 6. Such a size alteration is represented by the reduction in size of said copies from FIG. 5 to FIG. 6. Such size alteration may include enlargement or alteration of proportion by stretching or compressing in one direction or another, which is generally represented by Arrows L and W in FIG. 6.

With continued reference to FIG. 6, sides 26A and 26B are collinear and sides 28A and 28B are likewise collinear. Second copy 20B is merged with first copy 20A at a connection therebetween along second end 24A and second 24B of the respective copies. In the exemplary embodiment, ends 24A and 24B coincide although this is only shown by the dot-dash line of axis X because the two copies have seamlessly merged so that no border between the two is discernible except for the change of direction of the respective mirror image lines which respectively form part of copies 20A and 20B and which extend respectively to ends 24A and 24B thereof. The flipping and placement of second copy 20B thus makes second copy 20B a mirror image of first copy 20A with respect to axis X. First and second copies 20A and 20B thus form a single-mirrored detail section or first combined detail section 30A, which itself may be duplicated end to end (22A to 22B) to create a repeating pattern of sections 30A. Likewise, section 30A may be duplicated top to bottom or side to side (26 to 28) or in other arrangements (diagonal relationship, rotated to varying degrees, overlapping, etc.) to create alternate repeating patterns thereof.

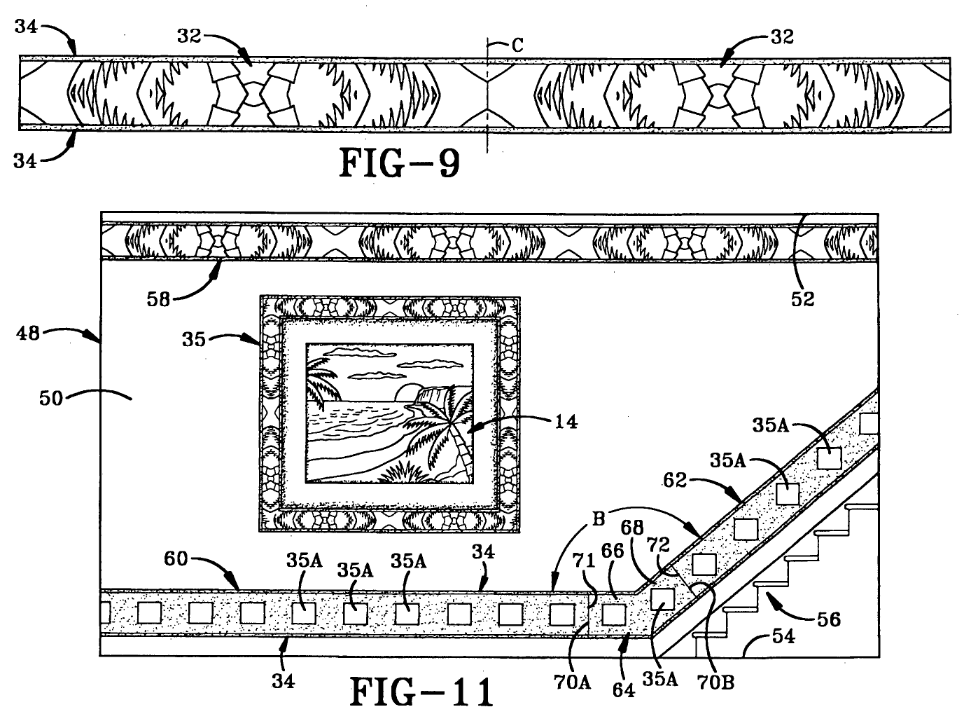

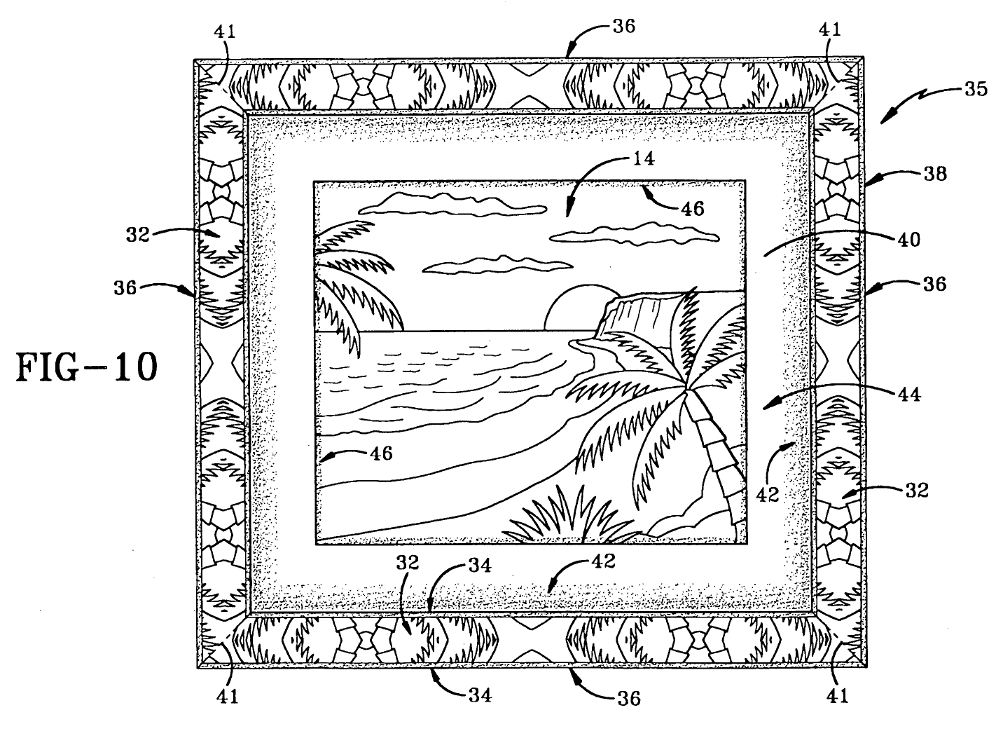

In the exemplary embodiment, section 30A is flipped or inverted about a horizontal axis Y to create a mirror image thereof, or a second combined detail section 30B (FIG. 7), which appears upside down relative to section 30A. Second section 30B includes third and fourth copies 20C and 20D, which are respectively mirror images of first and second copies 20A and 20B with respect to axis Y and are merged therewith in the same fashion noted above, except side to side (top to bottom) instead of end to end. Again, dot-dash lines represent axis Y and the seamless boundary between sections 30A and 30B. First and second sections 30A and 30B thus form a double-mirrored detail section 32 which includes first, second, third and fourth copies 20A-D having a four-quadrant arrangement with respect to axes X and Y. Third and fourth copies 20C and 20D have been labeled with ends and sides analogous to those of first and second copies 20A and 20B while respectively using “C” and “D” terminal indicators to clarify the respective orientations thereof. Thus, first copy 20A at second side 28A thereof is connected to and merged with third copy 20C at second side 28C thereof, which coincides with second side 28A. Likewise, second copy 20B at second side 28B thereof is connected to and merged with fourth copy 20D at second side 28D thereof, which coincides with second side 28B. Sides 26A and 26B are collinear, as they were before the formation of section 30B. In addition, sides 26C and 26D are collinear, ends 22A and 22C are collinear, and ends 22B and 22D are collinear. Double-mirrored detail section 32 (like section 30 alone) may be duplicated end to end (22 to 22) to create a repeating pattern of sections 32, as illustrated in FIGS. 9-11. Likewise, section 32 may be duplicated top to bottom or side to side (26 to 26) or in other arrangements to create alternate repeating patterns thereof. As discussed above related to earlier stages of the process, the size of sections 32 may be altered to suit the desired end result.

To accentuate and provide an appearance which may be more aesthetically pleasing, a molding strip 34 (FIG. 8) may be used with sections 30 or 32. FIG. 9 shows two strips 34 connected to the top and bottom (sides 26) of a pair of sections 32 formed by the copying of section 32 to form a duplicate thereof and placement of the duplicate to connect the two sections 32 end to end along a vertical axis C, a process which may be repeated as many times as desired to produce the desired result. A single strip 34 may be used along only one side of section 32 if desired. Strip 34 is substantially straight and parallel to sides 26 and 28, and is relatively narrow compared to sections 30 and 32. Strip 34 provides shadowing to add a three-dimensional appearance thereto, in particular to appear like a cylinder or semi-cylinder. However, other three-dimensional shapes may be represented or a similar molding strip may provide a two-dimensional appearance if desired. As shown in FIG. 9, strip 34 is typically connected to the repeated sections 32 (or repeated sections 30) along the entire length thereof.

Repeated sections 32 with molding strips 34 are then transferred to a target object to produce an aesthetically pleasing effect to the target object. For example, the pattern may be transferred to produce a framed work 35 (FIG. 10) via one or more decorative borders 36 adjacent digital image 14 of piece 10 of artwork. The use of borders 36 thus substantially adds to digital image 14 by utilizing detail section 20 which originated from image 14. More particularly, a pattern and colors derived from image 14 are used in conjunction therewith to pick up an artistic theme thereof which accentuates and/or complements image 14. This aspect of the invention is desirable in contrast to the use of standard frames which do not utilize such a theme of the artwork itself. In addition, the pattern and colors of section 20 inherently go with image 14 and thus guarantee a desirable match therewith. Borders 36 may extend adjacent all sides of image 14 to produce a decorative frame 38 which surrounds image 14.

Frame 38 may be a standard three-dimensional frame onto which the pattern is transferred to produce the decorative effect. However, one very desirable option is to print the pattern of repeated sections 32 and strips 34 on a flat surface 40 such as on a piece of paper or the like to produce a two-dimensional image thereon to form a virtual border 36 or virtual frame 38. In the exemplary embodiment, the sections 32 which meet at the corners of frame 38 have been altered by “cutting” or otherwise producing respective angled terminal ends 41, which typically mimic the 45-degree cut of adjoining frame members (represented by borders 36) of a standard frame. Preferably, shadowing 42 is provided along the interior of frame 38 to give a three-dimensional appearance to frame 38. Especially with the use of shadowing 42, the framed image 14 has become a high-quality two-dimensional finished product which appears as an artistic reproduction (image 14) having a three-dimensional frame. Thus, the two-dimensional aspect of the finished product allows for a high-quality artistic work which may be hung on a wall or elsewhere without the need for purchasing or building a frame for image 14. If desired, framed work 35 may include a virtual mat 44 by the use of additional shadowing 46 surrounding image 14 along its outer perimeter. It is also contemplated that a mat similar to mat 44 may be printed with a detail section image from digital image 14, which may be different than detail section 20 while still carrying a theme from image 14.

Another desirable finished product of the present invention is wall paper or other wall coverings, particularly in the form of wall borders, which are shown in use in a room 48 in FIG. 11. Room 48 has a wall 50 bounded by a ceiling 52 and a floor 54 with a staircase 56 angling upwardly from floor 54. A horizontal ceiling wall border 58 is connected to wall 50 adjacent and spaced downwardly from ceiling 52, extending parallel to ceiling 52. A pattern of repeated sections 32 and strips 34 printed on wall border 58 provides the decorative aspect thereto. Framed work 35 is shown hung on wall 50 below wall border 58 whereby wall border 58 and work 35 provide a matching theme for room 48 via the use of sections 32, thus echoing each other thematically via the theme material derived from image 14 of piece 10.

In addition, a horizontal baseboard wall border 60 is connected to wall 50 adjacent and spaced upwardly from floor 54, extending parallel to floor 54. Virtual molding strips 34 are used on the top and bottom of wall border 60. Wall border 60 ties into a theme common to work 35 and ceiling border 58 by including miniaturized works 35A which are identical to framed work 35 except for their smaller size. Thus, each work 35A includes a miniaturized image 14 and frame 38 having repeated images 32 thereon although detail of works 35A are not shown due to the size depicted in FIG. 11. Baseboard border 60 more particularly includes a plurality of works 35A spaced along the length thereof and disposed on border 60 so as to be in an upright position when border 60 is connected to wall 50. Thus, images 14, work 35 and the like may be duplicated to produce a plurality thereof which may be positioned in a spaced manner if desired and then transferred to a border or other desired object to produce a result such as border 60. It is noted that border 60 may tie into a theme common to border 58 and/or framed work 35 by use of images which are similar, but not identical to work 35 or image 14. Thus, for example, each work 35A may be a modified version of framed work 35 or include any suitable extract, modified or not, from image 14 of the source work.

A staircase wall border 62 is also attached to wall 50 adjacent staircase 56 and angles upwardly on the same angle as staircase 56. Staircase border 62 is similar to baseboard border 60 except that miniaturized works 35A are rotated to the side compared to the position of works 35A on baseboard border 60 so that works 35A on staircase border 62 are also in an upright position when border 62 is connected to wall 50 in its angled position adjacent staircase 56. Borders 58, 60 and 62 are typically produced in lengths on the order of 150 inches with a typical height of about 5¼ inches although any suitable length and height may be used. A typical border measuring 150 inches may include two, three, four or more repeating sections 30 or 32.

Conveniently, a wall border angle 64 provides a transition between baseboard border 60 and staircase border 62. Angle 64 includes first and second legs 66 and 68 which are formed as an integral one-piece member and which define therebetween an angle B which typically ranges from 24 to 34 degrees and more preferably is approximately 29 degrees, which is the standard for which a staircase angles upwardly from a horizontal floor. Angle 64 simplifies the installation of staircase border 62 when used with baseboard border 60 by providing the standard angle needed while eliminating the difficulty of trimming the pertinent ends of borders 60 and 62 at the correct angles. In addition, angle 64 includes a work 35A on first leg 66 which is positioned like those works 35A on baseboard border 60 and a work 35A on second leg 68 which is positioned like those works 35A on staircase border 62 so that when angle 64 is connected to wall 50, the works 35A on first and second legs 66 and 68 are in an upright position. Preferably, the works 35A on first and second legs 66 and 68 are also spaced from opposed ends 70A and 70B of angle 64 and respective works 35A of baseboard border 60 and staircase border 62 are spaced from respective ends 71 and 72 thereof so that borders 60 and 62 may be joined in abutment with angle 64 while providing suitable spacing between the works 35A on and adjacent angle 64. Preferably, this spacing is substantially the same as that between adjacent works 35A on border 60 and/or adjacent works 35A on border 62.

It is contemplated that while the legs of angle 64 are configured for use with a staircase, an angle may be formed where the legs are perpendicular or otherwise angled to facilitate the transition between two borders not associated with a staircase. For example, a horizontal and vertical border may be joined with an angle having perpendicular legs. Another of many possibilities includes angles having legs suitable angled which may be used with borders to create polygon configurations such as hexagons which may be used, for instance, to frame a like-shaped window and so forth.

Borders 58, 60, 62, angle 64 and the like are typically formed using commercial wall border printable papers onto which the digital images of the invention have been transferred. However, a variety of other commercial substrates may be used for this purpose. Such substrates are typically a flexible sheet of paper, plastic or polycarbonate material. Such borders are typically wound on spools for easy handling and may be provided commercially as independent wall border spool sets or with a choice of fully-coordinated matching murals, posters and prints which utilize detail section images such as section 20 in the various configurations described herein. Wall coverings including those represented by borders 58, 60, 62 and angle 64 are sold by Mural Solutions®, LLC of Fairlawn, Ohio under the registered trademark “ScrollWorx”.

The method of the present invention thus provides an effective and efficient process for reproducing digital images of art on various desired objects to provide an aesthetically pleasing, well balanced decorative effect thereto. The method includes a design formula sequence for digitizing original art to form, for example, creative-aesthetic wall accents and the like which are color-balanced and derived from a central-thematic art source. The method may be used with a wide variety of target objects and thus the images may be transferred to, for example, furniture coverings, T-shirts, towels, umbrellas, awnings, and more generally to various textiles, ceramics, wood, metal and so forth. It will be clear to one skilled in the art that the images may be applied to innumerable categories of materials and other particular target objects, and that those listed herein are not intended as imposing any limitation on the present invention.

Other variations within the scope of the present invention will be apparent to one skilled in the art. For example, because detail sections 20 may be of any shape, an infinite variety of shape patterns may be created by the present method. Thus, for instance, a detail section which is oval may form a shape pattern including a plurality of ovals adjacent one another generally end to end, top to bottom or otherwise. Such an option may produce oval detail sections which are merged or otherwise connected at certain points or areas while also leaving various spaces therebetween. Alternately, the ovals or other shapes may be spaced from one another without any connection therebetween while still providing a pattern of similar shapes and of copied portions of a digital image of a piece of artwork, wherein the copied portions may include mirror images as previously described herein. In addition, where spaces are left between adjacent copies of detail sections such as copies 20, molding strips analogous to strips 34 may be disposed between the various copies in any desired orientation to provide dividers therebetween. Also, while the borders and frames shown herein are substantially straight, the method may produce borders or frames which are arcuate and may for instance be used to form a circular frame. Further, the transferring of the digitally created images discussed herein may be accomplished by printing or alternate methods, such as weaving the various images or patterns discussed herein into a textile material or producing a piece of carpet with appropriate arrangements of colored pile to produce a likeness of the image or pattern. The digital images may also be applied as a glaze or the like to ceramic pieces and subsequently fired. Any suitable method known in the art may be used which is suited to the medium to which the image is to be applied.

The present invention is practiced in accordance with any applicable copyright laws. Thus, for example, Applicant typically applies the method to the Lowell S. V. Devin collection of original mixed-medium figurative representational art as a source of producing digital images of original pieces of artwork, as said collection is exclusively represented by Mural Solutions®, LLC of Fairlawn, Ohio.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A method comprising the steps of:
copying a portion of a digitized image of a piece of artwork to form a first digitized detail section image;
duplicating the first detail section image to form a second digitized detail section image; and
transferring the first and second detail section images to a target object.

2. The method of claim 1 further including the step of positioning the second detail section image adjacent the first detail section image.

3. The method of claim 3 wherein the step of positioning includes the step of connecting the second detail section image to the first detail section image.

4. The method of claim 1 further including the step of manipulating the second detail section image so that it forms a mirror image of the first detail section image whereby the first and second detail section images together form a first combined section.

5. The method of claim 4 wherein the step of manipulating includes the step of forming a mirror image of the first detail section image which is connected to the first detail section image.

6. The method of claim 4 further including the step of duplicating the first combined image to form a second combined image; and wherein the step of transferring includes the step of transferring the first and second combined images to the target object.

7. The method of claim 6 wherein the step of manipulating the second detail section image includes the step of forming a mirror image of the first detail section image with respect to a first axis; and further including the step of manipulating the second combined image to form a mirror image of the first combined image with respect to a second axis which is transverse to the first axis.

8. The method of claim 7 wherein the step of manipulating the second combined image includes step of manipulating the second combined image so that it forms a mirror image of the first combined image with respect to a second axis which is perpendicular to the first axis.

9. The method of claim 1 further including the step of altering the size of the first detail section image in at least one direction.

10. The method of claim 1 further including the steps of positioning a digital molding strip adjacent the first and second detail section images; and transferring the molding strip to the target object.

11. The method of claim 1 wherein the step of transferring includes the step of transferring the images to a wall covering.

12. The method of claim 11 wherein the step of transferring includes the step of transferring the images to a wall border.

13. The method of claim 12 wherein the step of transferring includes the step of transferring the images to a wall border angle having first and second segments which are connected to and angled with respect to one another.

14. The method of claim 12 further including the step of duplicating the digitized image of the piece of artwork to form a plurality thereof; positioning the plurality of digitized images so that they are spaced from one another; and transferring the plurality of spaced digitized images of the piece of artwork to the wall border.

15. The method of claim 1 wherein the step of transferring includes the step of transferring the images to a border disposed adjacent an image of the piece of artwork.

16. The method of claim 15 wherein the step of transferring includes the step of transferring the images to a border which surrounds the image of the piece of artwork to form a frame therefor.

17. The method of claim 1 wherein the step of transferring includes the step of transferring the images to form a two-dimensional border adjacent a two-dimensional image of the piece of artwork.

18. The method of claim 17 wherein the step of transferring includes the step of transferring the images to form a two-dimensional border which surrounds a two-dimensional image of the piece of artwork to form a two-dimensional frame therefor.

19. The method of claim 18 further including the step of creating two-dimensional shadowing adjacent the frame to give the frame a three-dimensional appearance.

20. The method of claim 19 further including the step of creating two-dimensional shadowing adjacent an outer perimeter of the image of the piece of artwork to give the impression of a three-dimensional mat surrounding the image of the piece of artwork.
